(19) United States
(12) Patent Application Publication
(10) Pub. No.: US 2020/0311795 A1
(43) Pub. Date: Oct. 1, 2020

(54) APPARATUS, METHOD, AND PROGRAM PRODUCT FOR DETERMINING A VENUE DESCRIPTION

(71) Applicant: LENOVO (Singapore) PTE. LTD., New Tech Park (SG)

(72) Inventors: Mark Patrick Delaney, Raleigh, NC (US); Nathan J. Peterson, Oxford, NC (US); Russell Speight VanBlon, Raleigh, NC (US); John Carl Mese, Cary, NC (US)

(21) Appl. No.: 16/367,178

(22) Filed: Mar. 27, 2019

(51) Int. Cl. G06Q 30/06

(52) U.S. Cl. CPC G06Q 30/0625

(57) ABSTRACT

Apparatuses, methods, and program products are disclosed for dynamically determining a venue description. One apparatus includes a processor and a memory that stores code executable by the processor. The code is executable by the processor to determine a venue corresponding to a user. The code is executable by the processor to determine an anticipated visit date, an anticipated visit time, or a combination thereof corresponding to a visit to the venue. The code is executable by the processor to obtain venue information corresponding to the anticipated visit date, the anticipated visit time, or a combination thereof. The code is executable by the processor to determine a venue description based on the venue information.

### FIELD

The subject matter disclosed herein relates to venue descriptions and more particularly relates to dynamically determining a venue description.

### BACKGROUND

### Description of the Related Art

Information handling devices, such as desktop computers, laptop computers, tablet computers, smart phones, optical head-mounted display units, smart watches, televisions, streaming devices, etc., are ubiquitous in society. These information handling devices may be used for performing various actions. For example, an information handling device may be used to provide information to a user.

### BRIEF SUMMARY

An apparatus for dynamically determining a venue description is disclosed. A method and computer program product also perform the functions of the apparatus. In one embodiment, the apparatus includes a processor and a memory that stores code executable by the processor. The code, in various embodiments, is executable by the processor to determine a venue corresponding to a user. The code, in certain embodiments, is executable by the processor to determine an anticipated visit date, an anticipated visit time, or a combination thereof corresponding to a visit to the venue. The code, in some embodiments, is executable by the processor to obtain venue information corresponding to the anticipated visit date, the anticipated visit time, or a combination thereof. The code, in various embodiments, is executable by the processor to determine a venue description based on the venue information.

In some embodiments, the code is executable by the processor to receive information from the user, and the information indicates the venue. In one embodiment, the venue is selected from a group including a business, a restaurant, an amusement park, an attraction venue, a play venue, a party venue, a movie theatre, a zoo, a bar, and a church.

In various embodiments, the anticipated visit date, the anticipated visit time, or a combination thereof includes a current date and a current time. In some embodiments, the current date and the current time are relative to a time to travel to the venue.

A method for dynamically determining a venue description, in one embodiment, includes determining a venue corresponding to a user. In certain embodiments, the method includes determining an anticipated visit date, an anticipated visit time, or a combination thereof corresponding to a visit to the venue. In some embodiments, the method includes obtaining venue information corresponding to the anticipated visit date, the anticipated visit time, or a combination thereof. In various embodiments, the method includes determining a venue description based on the venue information.

In some embodiments, the method includes receiving information from the user, wherein the information indicates the venue. In various embodiments, the venue is selected from a group including a business, a restaurant, an amusement park, an attraction venue, a play venue, a party venue, a movie theatre, a zoo, a bar, and a church.

In one embodiment, the anticipated visit date, the anticipated visit time, or a combination thereof includes a current date and a current time. In some embodiments, the current date and the current time are relative to a time to travel to the venue. In certain embodiments, the anticipated visit date, the anticipated visit time, or a combination thereof includes a future date, a future time, or a combination thereof.

In some embodiments, obtaining the venue information includes obtaining information corresponding to at least one patron of the venue, obtaining information from at least one sensor in the venue, obtaining information about events occurring at the venue, obtaining historical information corresponding to the venue, or some combination thereof. In various embodiments, the information corresponding to the at least one patron of the venue includes a user profile, user feedback, a social media post, user demographics, or some combination thereof. In certain embodiments, the method includes providing the venue description to the user.

In one embodiment, a program product includes a computer readable storage medium that stores code executable by a processor. The executable code, in certain embodiments, includes code to perform determining a venue corresponding to a user. The executable code, in various embodiments, includes code to perform determining an anticipated visit date, an anticipated visit time, or a combination thereof corresponding to a visit to the venue. The executable code, in some embodiments, includes code to perform obtaining venue information corresponding to the anticipated visit date, the anticipated visit time, or a combination thereof. The executable code, in certain embodiments, includes code to perform determining a venue description based on the venue information.

In certain embodiments, the anticipated visit date, the anticipated visit time, or a combination thereof includes a current date and a current time. In one embodiment, the anticipated visit date, the anticipated visit time, or a combination thereof includes a future date, a future time, or a combination thereof. In certain embodiments, obtaining the venue information includes obtaining information corresponding to at least one patron of the venue, obtaining information from at least one sensor in the venue, obtaining information about events occurring at the venue, obtaining historical information corresponding to the venue, or some combination thereof.

In various embodiments, the information corresponding to the at least one patron of the venue includes a user profile, user feedback, a social media post, user demographics, or some combination thereof. In some embodiments, the executable code further includes code to perform providing the venue description to the user.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a system for dynamically determining a venue description;

FIG. 2 is a schematic block diagram illustrating one embodiment of an apparatus including an information handling device;

FIG. 3 is a schematic block diagram illustrating one embodiment of an apparatus including a dynamic venue feedback module;

FIG. 4 is a schematic block diagram illustrating another embodiment of an apparatus including a dynamic venue feedback module;

FIG. 5 is a schematic flow chart diagram illustrating an embodiment of a method for dynamically determining a venue description; and

FIG. 6 is a schematic flow chart diagram illustrating another embodiment of a method for dynamically determining a venue description.

### DETAILED DESCRIPTION

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Certain of the functional units described in this specification have been labeled as modules, in order to more particularly emphasize their implementation independence. For example, a module may be implemented as a hardware circuit comprising custom very-large-scale integration (“VLSI”) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, include one or more physical or logical blocks of executable code which may, for instance, be organized as an object, procedure, or function. Nevertheless, the executables of an identified module need not be physically located together, but may include disparate instructions stored in different locations which, when joined logically together, include the module and achieve the stated purpose for the module.

Indeed, a module of code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Code for carrying out operations for embodiments may be written in any combination of one or more programming languages including an object oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”) or a wide area network (“WAN”), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. These code may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams block or blocks.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

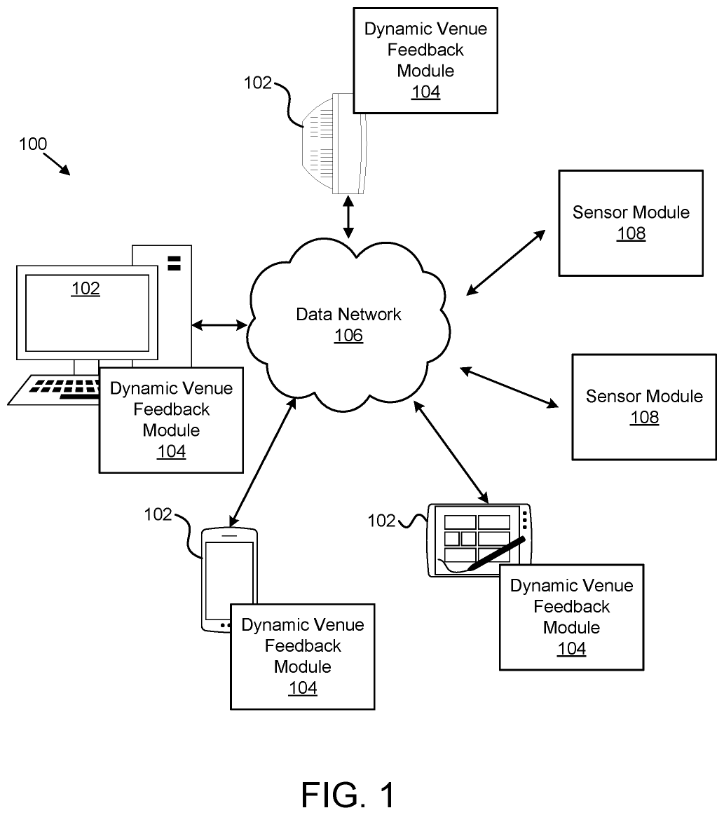

FIG. 1 depicts one embodiment of a system 100 for dynamically determining a venue description. In one embodiment, the system 100 includes information handling devices 102, dynamic venue feedback modules 104, data networks 106, and sensor modules 108. Even though a specific number of information handling devices 102, dynamic venue feedback modules 104, data networks 106, and sensor modules 108 are depicted in FIG. 1, one of skill in the art will recognize that any number of information handling devices 102, dynamic venue feedback modules 104, data networks 106, and sensor modules 108 may be included in the system 100.

In one embodiment, the information handling devices 102 include computing devices, such as desktop computers, laptop computers, personal digital assistants (PDAs), tablet computers, servers, smart phones, cellular phones, smart televisions (e.g., televisions connected to the Internet), set-top boxes, game consoles, security systems (including security cameras), vehicle on-board computers, network devices (e.g., routers, switches, modems), streaming devices, or the like. In some embodiments, the information handling devices 102 include wearable devices, such as smart watches, fitness bands, optical head-mounted displays, or the like. The information handling devices 102 may access the data network 106 directly using a network connection.

The information handling devices 102 may include an embodiment of the dynamic venue feedback module 104. In certain embodiments, the dynamic venue feedback module 104 may determine a venue corresponding to a user. The dynamic venue feedback module 104 may also determine an anticipated visit date, an anticipated visit time, or a combination thereof corresponding to a visit to the venue. In some embodiments, the dynamic venue feedback module 104 may obtain venue information (e.g., via one or more sensor modules 108) corresponding to the anticipated visit date, the anticipated visit time, or a combination thereof. In various embodiments, the dynamic venue feedback module 104 may determine a venue description based on the venue information. In this manner, the dynamic venue feedback module 104 may be used for dynamically determining a venue description.

The data network 106, in one embodiment, includes a digital communication network that transmits digital communications. The data network 106 may include a wireless network, such as a wireless cellular network, a local wireless network, such as a Wi-Fi network, a Bluetooth® network, a near-field communication (“NFC”) network, an ad hoc network, and/or the like. The data network 106 may include a WAN, a storage area network (“SAN”), a LAN, an optical fiber network, the internet, or other digital communication network. The data network 106 may include two or more networks. The data network 106 may include one or more servers, routers, switches, and/or other networking equipment. The data network 106 may also include computer readable storage media, such as a hard disk drive, an optical drive, non-volatile memory, RAM, or the like.

The sensor module 108 may include any suitable type of sensor used to obtain information about a venue. For example, the sensor module 108 may include one or more sensors. As another example, the sensor module 108, or a sensor of the sensor module, may include a camera, a microphone, a data gathering device, a Bluetooth® usage detector, a Wi-Fi usage detector, and/or the like.

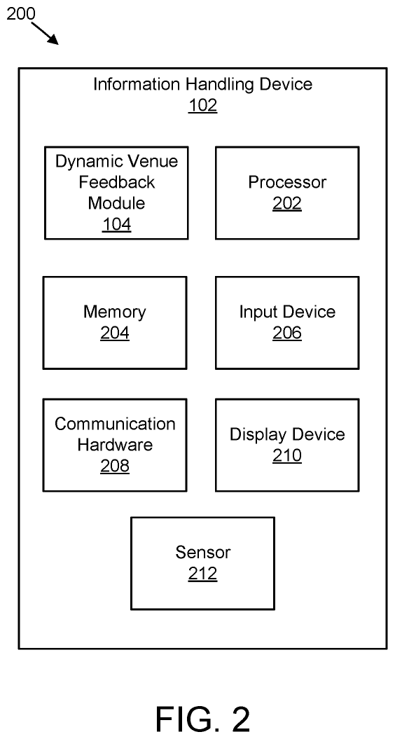

FIG. 2 depicts one embodiment of an apparatus 200 that may be used for dynamically determining a venue description. The apparatus 200 includes one embodiment of the information handling device 102. Furthermore, the information handling device 102 may include the dynamic venue feedback module 104, a processor 202, a memory 204, an input device 206, communication hardware 208, a display device 210, and a sensor 212. In some embodiments, the input device 206 and the display device 210 are combined into a single device, such as a touchscreen.

The processor 202, in one embodiment, may include any known controller capable of executing computer-readable instructions and/or capable of performing logical operations. For example, the processor 202 may be a microcontroller, a microprocessor, a central processing unit (“CPU”), a graphics processing unit (“GPU”), an auxiliary processing unit, a field programmable gate array (“FPGA”), or similar programmable controller. In some embodiments, the processor 202 executes instructions stored in the memory 204 to perform the methods and routines described herein. The processor 202 is communicatively coupled to the memory 204, the dynamic venue feedback module 104, the input device 206, the communication hardware 208, the display device 210, and the sensor 212.

The memory 204, in one embodiment, is a computer readable storage medium. In some embodiments, the memory 204 includes volatile computer storage media. For example, the memory 204 may include a RAM, including dynamic RAM (“DRAM”), synchronous dynamic RAM (“SDRAM”), and/or static RAM (“SRAM”). In some embodiments, the memory 204 includes non-volatile computer storage media. For example, the memory 204 may include a hard disk drive, a flash memory, or any other suitable non-volatile computer storage device. In some embodiments, the memory 204 includes both volatile and non-volatile computer storage media.

In some embodiments, the memory 204 stores data relating to dynamically determining a venue description. In some embodiments, the memory 204 also stores program code and related data, such as an operating system or other controller algorithms operating on the information handling device 102.

The information handling device 102 may use the dynamic venue feedback module 104 for dynamically determining a venue description. As may be appreciated, the dynamic venue feedback module 104 may include computer hardware, computer software, or a combination of both computer hardware and computer software. For example, the dynamic venue feedback module 104 may include circuitry, or a processor, used to determine a venue corresponding to a user. As another example, the dynamic venue feedback module 104 may include computer program code that determines an anticipated visit date, an anticipated visit time, or a combination thereof corresponding to a visit to the venue. As a further example, the dynamic venue feedback module 104 may include computer program code that obtains venue information corresponding to the anticipated visit date, the anticipated visit time, or a combination thereof. As yet another example, the dynamic venue feedback module 104 may include computer program code that determines a venue description based on the venue information.

The input device 206, in one embodiment, may include any known computer input device including a touch panel, a button, a keyboard, a stylus, or the like. In some embodiments, the input device 206 may be integrated with the display device 210, for example, as a touchscreen or similar touch-sensitive display. In some embodiments, the input device 206 includes a touchscreen such that text may be input using a virtual keyboard displayed on the touchscreen and/or by handwriting on the touchscreen. In some embodiments, the input device 206 includes two or more different devices, such as a keyboard and a touch panel. The communication hardware 208 may facilitate communication with other devices. For example, the communication hardware 208 may enable communication via Bluetooth®, Wi-Fi, and so forth.

The display device 210, in one embodiment, may include any known electronically controllable display or display device. The display device 210 may be designed to output visual, audible, and/or haptic signals. In some embodiments, the display device 210 includes an electronic display capable of outputting visual data to a user. For example, the display device 210 may include, but is not limited to, an LCD display, an LED display, an OLED display, a projector, or similar display device capable of outputting images, text, or the like to a user. As another, non-limiting, example, the display device 210 may include a wearable display such as a smart watch, smart glasses, a heads-up display, or the like. Further, the display device 210 may be a component of a smart phone, a personal digital assistant, a television, a table computer, a notebook (laptop) computer, a personal computer, a vehicle dashboard, a streaming device, or the like.

In certain embodiments, the display device 210 includes one or more speakers for producing sound. For example, the display device 210 may produce an audible alert or notification (e.g., a beep or chime). In some embodiments, the display device 210 includes one or more haptic devices for producing vibrations, motion, or other haptic feedback. For example, the display device 210 may produce haptic feedback upon performing an action.

In some embodiments, all or portions of the display device 210 may be integrated with the input device 206. For example, the input device 206 and display device 210 may form a touchscreen or similar touch-sensitive display. In other embodiments, the display device 210 may be located near the input device 206. In certain embodiments, the display device 210 may receive instructions and/or data for output from the processor 202 and/or the dynamic venue feedback module 104.

The sensor 212 may be any suitable type of sensor that can obtain information about a venue. For example, the sensor 212 may include a camera, a microphone, a data gathering device, a Bluetooth® usage detector, a Wi-Fi usage detector, and/or the like.

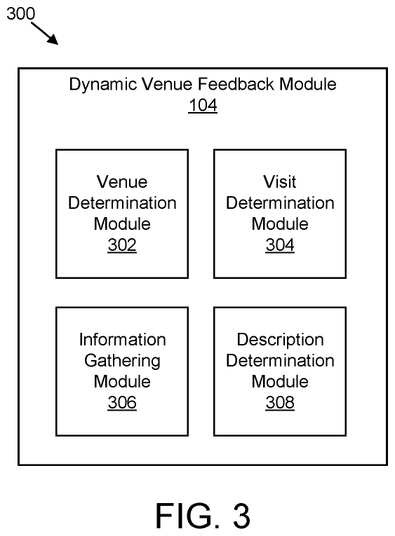

FIG. 3 depicts a schematic block diagram illustrating one embodiment of an apparatus 300 that includes one embodiment of the dynamic venue feedback module 104. Furthermore, the dynamic venue feedback module 104 includes a venue determination module 302, a visit determination module 304, an information gathering module 306, and a description determination module 308.

In certain embodiments, the venue determination module 302 may determine a venue corresponding to a user. The venue determination module 302 may determine the venue using information obtained via: the user searching for the venue, the user selecting the venue, the user indicating the venue, the user indicating an interest in the venue, the user indicating an interest in a type of venue, the user indicating an interest in an event, artificial intelligence corresponding to information provided by the user, and so forth. In various embodiments, the venue is selected from a group including a business, a restaurant, an amusement park, an attraction venue, a play venue, a party venue, a movie theatre, a zoo, a bar, a church, and/or the like.

In one embodiment, the visit determination module 304 may determine an anticipated visit date and/or an anticipated visit time corresponding to a visit to the venue. The visit determination module 304 may determine the anticipated visit date and/or the anticipated visit time corresponding to the visit using information obtained via: the user indicating a date and/or a time for the visit, the user indicating an immediate visit to the venue, the user requesting an event held ad the venue, the user's preferences, the user's habits, the user's history, a calendar event, a recurring event, and/or the like.

In some embodiments, the anticipated visit date and/or the anticipated visit time includes a current date and/or a current time. In such embodiments, the current date and/or the current time may be relative to a time to travel to the venue. For example, the venue may be a ten minute drive from the user's current location, therefore the current date and/or the current time may be ten minutes later than an actual date and/or an actual time. In certain embodiments, the anticipated visit date and/or the anticipated visit time includes a future date and/or a future time. For example, the user may anticipate a visit to the venue next Thursday at 5:30 pm (e.g., a future date and a future time).

In various embodiments, the information gathering module 306 may obtain venue information corresponding to the anticipated visit date and/or the anticipated visit time. In some embodiments, obtaining the venue information includes obtaining information corresponding to at least one patron of the venue, obtaining information from at least one sensor (e.g., the sensor module 108, the sensor 212, a microphone, a camera, a Bluetooth® usage detector, a Wi-Fi usage detector, etc.) in the venue, obtaining information about events occurring at the venue, obtaining historical information corresponding to the venue, and/or the like.

In certain embodiments, the information corresponding to the at least one patron of the venue includes a user profile, user feedback, a social media post, user demographics, and/or the like. The information corresponding to the at least one patron of the venue may be obtained: by asking the at least one patron for feedback and/or information; by detecting that the at least one patron is at the venue and accessing user profiles, the social media posts, and/or the user demographics corresponding to the at least one patron; and/or by detecting a visit of the at least one patron to the venue and accessing user profiles, the social media posts, and/or the user demographics corresponding to the at least one patron.

As may be appreciated, the venue may have one or more sensors used to detect information about the venue and/or one or more sensors in user's devices may be used to detect information about the venue. The one or more sensors may detect a sound level of the venue, topics of conversation in the venue, a number of people in the venue, events occurring in the venue, entertainment occurring at the venue (e.g., live entertainment, television entertainment, etc.), demographics of patrons to the venue, an atmosphere of the venue, and so forth.

In some embodiments, information about events occurring at the venue may be obtained via: posts found in social media; a website corresponding to the venue; blogs; calendars; event websites; user provided information; sensor detected information; and/or the like.

In various embodiments, historical information corresponding to the venue may be obtained via: historical sensor information; historical events that have occurred at the venue; historical demographic information bout the venue; news stories about the venue; user posts about the venue; and/or the like.

In certain embodiments, the description determination module 308 may determine a venue description based on the venue information. This venue description is dynamic so that it may change based on a date, a time, an event, sensor information, user information, a user accessing the venue description, and/or other things that correspond to the venue. Thus, the venue description may be dynamically changed relative to a user's anticipated visit to the venue. As used herein, a venue description may include text (e.g., a textual description of the venue), one or more icons (e.g., icons corresponding to word—such as an icon for loud or party, for example), one or more graphics, one or more pictures (e.g., a picture from within the venue—such as a picture of the current atmosphere of the venue or a prior atmosphere of the venue, etc.), one or more logos (e.g., sports team logos, company logos, product logos, etc.), one or more links (e.g., a link to an event, etc.), audio (e.g., audio sample from the venue, etc.), video (e.g., video clip of the venue—such as a video of the current atmosphere of the venue or a prior atmosphere of the venue, etc.), and/or other items that may be used to describe and/or characterize a venue.

One example of operation of the dynamic venue feedback module 104 is illustrated in the following scenario. Jimmy desires to take his family to a family restaurant. Jimmy finds a restaurant called “Homestyle Bistro.” The information gathering module 306 determines that: a college football game for a local college is currently on channel 5 of a television at the Homestyle Bistro and the game is scheduled to end in 2 hours from now; patrons of Homestyle Bistro describe themselves as fans of the local college football team; and a social media platform indicates a current event happening titled “Crazy Football Watch Party.” Based on the venue information gathered by the information gathering module 306, the description determination module 308 changes a non-dynamic description of the venue from “traditional American eats, local beers & spirits in a sports-themed setting with multiple TVs” to a dynamic description of the venue as “sport hearty venue with a lot of energy, beer and American eats. Be prepared to get on your feet for the local college home football game.”

In certain embodiments, the dynamic venue feedback module 104 includes a feedback loop that verifies descriptions determined by the description determination module 308. The feedback loop may request feedback from patrons to the venue requesting whether the dynamic description of the venue accurately describes the current environment of the venue. This may help the description determination module 308 to develop greater accuracy in its dynamic descriptions. Moreover, as described herein, the dynamic venue feedback module 104 may provide real-time, dynamically produced, and/or user tailored descriptions of a venue so that a potential patron of the venue may determine whether they want to visit the venue at an anticipated date and/or an anticipated time. It should be noted that static descriptions of a venue are not tailored to specific events, specific times, and/or specific potential patrons so their usage value to a potential patron is reduced because they may not provide enough information to a potential patron to help the potential patron decide if they want to visit the venue.

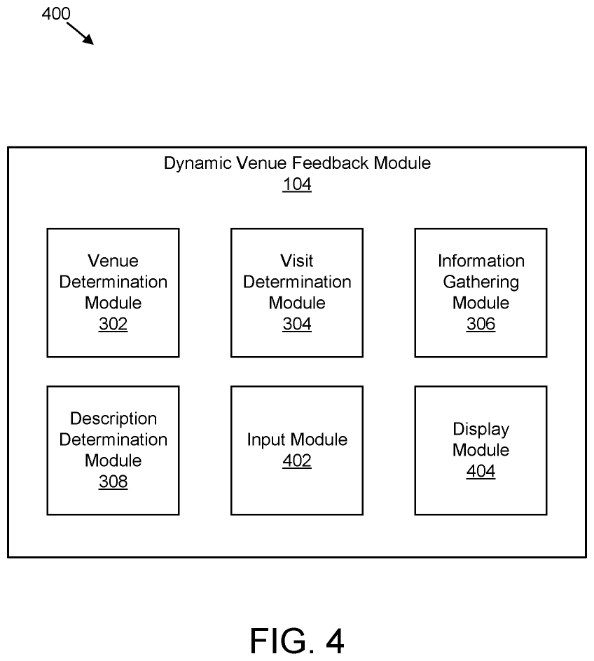

FIG. 4 is a schematic block diagram illustrating another embodiment of an apparatus 400 that includes one embodiment of the dynamic venue feedback module 104. Furthermore, the dynamic venue feedback module 104 includes one embodiment of the venue determination module 302, the visit determination module 304, the information gathering module 306, and the description determination module 308, that may be substantially similar to the venue determination module 302, the visit determination module 304, the information gathering module 306, and the description determination module 308 described in relation to FIG. 3. The dynamic venue feedback module 104 also includes an input module 402 and a display module 404.

In some embodiments, the input module 402 may receive information from the user. In such embodiments, the information may indicate the venue. The information may be obtained via: the user searching for the venue, the user selecting the venue, the user indicating the venue, the user indicating an interest in the venue, the user indicating an interest in a type of venue, the user indicating an interest in an event, artificial intelligence corresponding to information provided by the user, and so forth.

In certain embodiments, the display module 404 may provide the venue description to the user. For example, the display module 404 may: insert the venue description into search results corresponding to the venue; insert the venue description into a listing for the venue; send the venue description to the user; and/or otherwise provide the venue description to the user.

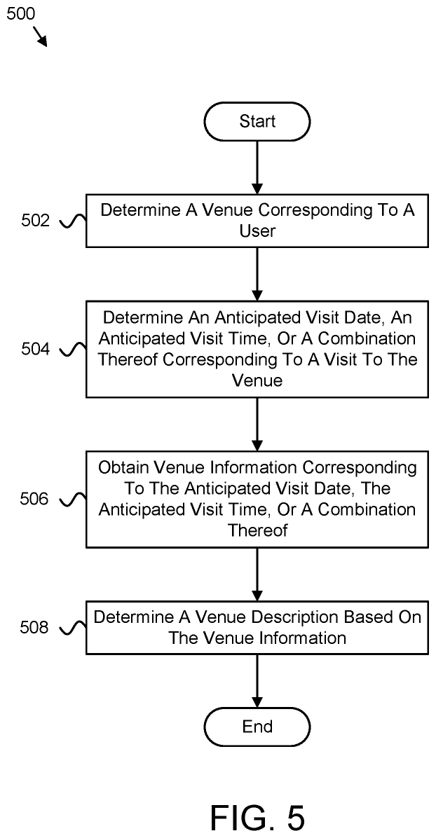

FIG. 5 is a schematic flow chart diagram illustrating an embodiment of a method 500 for dynamically determining a venue description. In some embodiments, the method 500 is performed by an apparatus, such as the information handling device 102. In other embodiments, the method 500 may be performed by a module, such as the dynamic venue feedback module 104. In certain embodiments, the method 500 may be performed by a processor executing program code, for example, a microcontroller, a microprocessor, a CPU, a GPU, an auxiliary processing unit, a FPGA, or the like.

The method 500 may include determining 502 a venue corresponding to a user. In certain embodiments, the venue determination module 302 may determine 502 the venue corresponding to the user. In some embodiments, the venue is selected from a group including a business, a restaurant, an amusement park, an attraction venue, a play venue, a party venue, a movie theatre, a zoo, a bar, a church, and/or the like.

The method 500 may include determining 504 an anticipated visit date and/or an anticipated visit time corresponding to a visit to the venue. In some embodiments, the visit determination module 304 may determine 504 the anticipated visit date and/or the anticipated visit time corresponding to the visit to the venue. In various embodiments, the anticipated visit date and/or the anticipated visit time includes a current date and a current time. In certain embodiments, the current date and the current time are relative to a time to travel to the venue. In some embodiments, the anticipated visit date and/or the anticipated visit time includes a future date and/or a future time.

The method 500 may include obtaining 506 venue information corresponding to the anticipated visit date and/or the anticipated visit time. In some embodiments, the information gathering module 306 may obtain 506 the venue information corresponding to the anticipated visit date and/or the anticipated visit time. In certain embodiments, obtaining the venue information includes obtaining information corresponding to at least one patron of the venue, obtaining information from at least one sensor in the venue, obtaining information about events occurring at the venue, obtaining historical information corresponding to the venue, and/or the like. In various embodiments, the information corresponding to the at least one patron of the venue includes a user profile, user feedback, a social media post, user demographics, and/or the like.

The method 500 may include determining 508 a venue description based on the venue information, and the method 500 may end. In some embodiments, the description determination module 308 may determine 508 the venue description based on the venue information.

In some embodiments, the method 500 includes receiving information from the user, wherein the information indicates the venue. In various embodiments, the method 500 includes providing the venue description to the user.

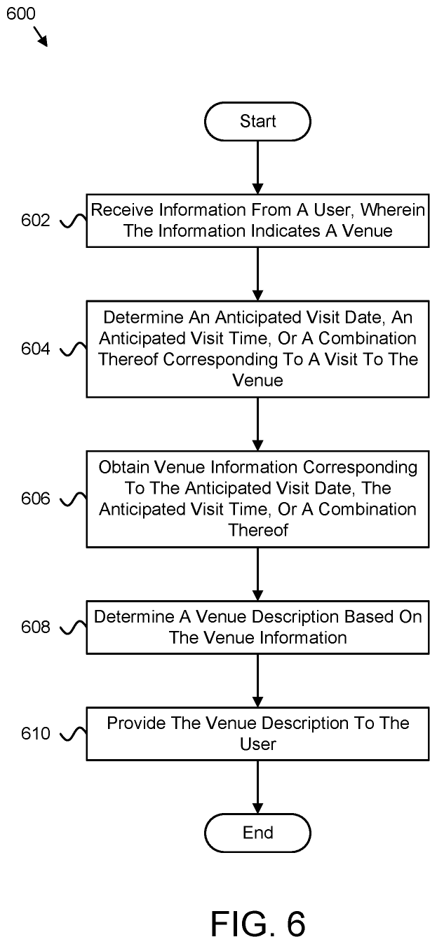

FIG. 6 is a schematic flow chart diagram illustrating another embodiment of a method 600 for dynamically determining a venue description. In some embodiments, the method 600 is performed by an apparatus, such as the information handling device 102. In other embodiments, the method 600 may be performed by a module, such as the dynamic venue feedback module 104. In certain embodiments, the method 600 may be performed by a processor executing program code, for example, a microcontroller, a microprocessor, a CPU, a GPU, an auxiliary processing unit, a FPGA, or the like.

The method 600 may include receiving 602 information from a user. The information indicates a venue. In certain embodiments, the input module 402 may receive 602 the information from the user. In some embodiments, the venue is selected from a group including a business, a restaurant, an amusement park, an attraction venue, a play venue, a party venue, a movie theatre, a zoo, a bar, a church, and/or the like.

The method 600 may include determining 604 an anticipated visit date and/or an anticipated visit time corresponding to a visit to the venue. In some embodiments, the visit determination module 304 may determine 604 the anticipated visit date and/or the anticipated visit time corresponding to the visit to the venue. In various embodiments, the anticipated visit date and/or the anticipated visit time includes a current date and a current time. In certain embodiments, the current date and the current time are relative to a time to travel to the venue. In some embodiments, the anticipated visit date and/or the anticipated visit time includes a future date and/or a future time.

The method 600 may include obtaining 606 venue information corresponding to the anticipated visit date and/or the anticipated visit time. In some embodiments, the information gathering module 306 may obtain 606 the venue information corresponding to the anticipated visit date and/or the anticipated visit time. In certain embodiments, obtaining the venue information includes obtaining information corresponding to at least one patron of the venue, obtaining information from at least one sensor in the venue, obtaining information about events occurring at the venue, obtaining historical information corresponding to the venue, and/or the like. In various embodiments, the information corresponding to the at least one patron of the venue includes a user profile, user feedback, a social media post, user demographics, and/or the like.

The method 600 may include determining 608 a venue description based on the venue information. In some embodiments, the description determination module 308 may determine 608 the venue description based on the venue information.

In various embodiments, the method 600 includes providing 610 the venue description to the user, and the method 600 may end. In certain embodiments, the display module 404 may provide 610 the venue description to the user.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus comprising:
a processor; and
a memory that stores code executable by the processor to:
determine a venue corresponding to a user;
determine an anticipated visit date, an anticipated visit time, or a combination thereof corresponding to a visit to the venue;
obtain venue information corresponding to the anticipated visit date, the anticipated visit time, or a combination thereof; and
determine a venue description based on the venue information.

2. The apparatus of claim 1, wherein the code is executable by the processor to receive information from the user, and the information indicates the venue.

3. The apparatus of claim 1, wherein the venue is selected from a group comprising a business, a restaurant, an amusement park, an attraction venue, a play venue, a party venue, a movie theatre, a zoo, a bar, and a church.

4. The apparatus of claim 1, wherein the anticipated visit date, the anticipated visit time, or a combination thereof comprises a current date and a current time.

5. The apparatus of claim 4, wherein the current date and the current time are relative to a time to travel to the venue.

6. A method comprising:
determining a venue corresponding to a user;
determining an anticipated visit date, an anticipated visit time, or a combination thereof corresponding to a visit to the venue;
obtaining venue information corresponding to the anticipated visit date, the anticipated visit time, or a combination thereof; and
determining a venue description based on the venue information.

7. The method of claim 6, further comprising receiving information from the user, wherein the information indicates the venue.

8. The method of claim 6, wherein the venue is selected from a group comprising a business, a restaurant, an amusement park, an attraction venue, a play venue, a party venue, a movie theatre, a zoo, a bar, and a church.

9. The method of claim 6, wherein the anticipated visit date, the anticipated visit time, or a combination thereof comprises a current date and a current time.

10. The method of claim 9, wherein the current date and the current time are relative to a time to travel to the venue.

11. The method of claim 6, wherein the anticipated visit date, the anticipated visit time, or a combination thereof comprises a future date, a future time, or a combination thereof.

12. The method of claim 6, wherein obtaining the venue information comprises obtaining information corresponding to at least one patron of the venue, obtaining information from at least one sensor in the venue, obtaining information about events occurring at the venue, obtaining historical information corresponding to the venue, or some combination thereof.

13. The method of claim 12, wherein the information corresponding to the at least one patron of the venue comprises a user profile, user feedback, a social media post, user demographics, or some combination thereof.

14. The method of claim 6, further comprising providing the venue description to the user.

15. A program product comprising a computer readable storage medium that stores code executable by a processor, the executable code comprising code to perform:
determining a venue corresponding to a user;
determining an anticipated visit date, an anticipated visit time, or a combination thereof corresponding to a visit to the venue;
obtaining venue information corresponding to the anticipated visit date, the anticipated visit time, or a combination thereof; and
determining a venue description based on the venue information.

16. The program product of claim 15, wherein the anticipated visit date, the anticipated visit time, or a combination thereof comprises a current date and a current time.

17. The program product of claim 15, wherein the anticipated visit date, the anticipated visit time, or a combination thereof comprises a future date, a future time, or a combination thereof.

18. The program product of claim 15, wherein obtaining the venue information comprises obtaining information corresponding to at least one patron of the venue, obtaining information from at least one sensor in the venue, obtaining information about events occurring at the venue, obtaining historical information corresponding to the venue, or some combination thereof.

19. The program product of claim 15, wherein the information corresponding to the at least one patron of the venue comprises a user profile, user feedback, a social media post, user demographics, or some combination thereof.

20. The program product of claim 15, wherein the executable code further comprises code to perform providing the venue description to the user.
